(19) United States
(12) Patent Application Publication
(10) Pub. No.: US 2009/0100380 A1
(43) Pub. Date: Apr. 16, 2009

(54) Navigating through content

(75) Inventors: Grant Christopher Gardner, Seattle, WA (US); Jason Robert Tuck, Bellevue, WA (US); Li Chen Lim, Seattle, WA (US); David Wayne Flynt, Seattle, WA (US); Jay Ongg, Redmond, WA (US); Nisheth Pinakin Joshi, Sammamish, WA (US); Arthur Ka Tsuen Lam, Issaquah, WA (US); Alper Selcuk, Redmond, WA (US); Malti Raghavan, Redmond, WA (US); Aditya Shrivastava, Bothell, WA (US); Rebecca Sundling, Beijing (CN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/871,781

(22) Filed: Oct. 12, 2007

(51) Int. Cl. G06F 3/048

(52) U.S. Cl. 715/854

(57) ABSTRACT

Navigating among content data via a navigation interface includes receiving navigational input including category input and/or page input. The category input and page input each can be selected regardless of what page is currently selected. The selected page fills a substantial portion of the display space. A navigation bar including display elements of available categories also can be displayed. Touch support can be implemented using at least two different systems: Tap and Gesture. Gesture navigation can be inverted to suit the style of a particular user.

### BACKGROUND

Mobile electronic devices, such as personal desktop assistants, contemporary mobile telephones, hand-held computers, tablet personal computers, laptop personal computers, “smart” phones, and the like are becoming popular user tools. These electronic devices can run a general purpose operating system, such as MICROSOFT WINDOWS® Mobile, and can have a rich set of functionalities including e-mail access, Internet capabilities, document editing, calendar functions, music players, and even games. Such features and capabilities have increased both the utility and complexity of mobile devices.

Mobile electronic devices tend to be small, lightweight and easily portable. Consequently, these mobile devices typically have limited display space. Providing access to the volume and variety of available information and services, therefore, tends to clutter the user interface, thereby inhibiting users from accessing features or entering, retrieving, and/or viewing data. Users can become frustrated when they are unable to locate the desired information or services and may be unable to fully exploit the advantages of the mobile device.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Navigating through content data includes receiving navigational input; cycling through categories to select a new category; and cycling through the pages associated with the selected category to select a new page. Category and pages can be cycled regardless of which page is the currently selected and displayed. According to aspects of the disclosure, the selected page fills a substantial portion of the display space.

Navigational instructions can be provided through touch-sensitive displays. Such displays can support two different communication styles: Tap and Gesture. Gesture-based navigation can be inverted to suit the style of a particular user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram of an example navigational user interface within which a user can access stored content data and available services on an electronic device according to the principles of the disclosure;

FIG. 2 is a block diagram of a suitable computing environment in which embodiments of the navigational user interface of FIG. 1 may be implemented in accordance with the principles of the disclosure;

FIG. 3 is a block diagram of an example mobile electronic device providing a computing environment on which the navigational user interface of FIG. 1 can be implemented to provide access to content data and available services in accordance with the principles of the disclosure;

FIG. 4 is a schematic diagram of navigational flow paths through content data stored on an electronic device in accordance with the principles of the disclosure;

FIG. 5 is a schematic diagram of a user interface having features that are examples of inventive aspects in accordance with the present disclosure;

FIG. 6 is a schematic diagram of another user interface having features that are examples of inventive aspects in accordance with the present disclosure;

FIG. 7 is a flowchart illustrating an operational flow for an example navigation process for navigating through content data on an electronic device in accordance with the present disclosure;

FIG. 8 illustrates an operational flow for an ascertain process for implementing the receive operation of the navigation process of FIG. 7 in accordance with the present disclosure;

FIGS. 9 and 10 illustrate different operational flows for traversal processes for implementing the traverse operation of the navigation process of FIG. 7 in accordance with the present disclosure;

FIG. 11 is a flowchart illustrating an operational flow for an example software traversal process for navigating through software applications on an electronic device in accordance with the present disclosure;

FIG. 12 is a schematic diagram of a user interface having features that are examples of inventive aspects in accordance with the present disclosure;

FIG. 13 is a flowchart illustrating an operational flow for an example cycling process by which a category may be selected quickly in accordance with the present disclosure;

FIG. 14 is a flowchart illustrating an operational flow for an example display process for indicating when the navigational user interface is implementing accelerated cycling in accordance with the present disclosure;

FIG. 15 is an example navigational user interface having features that are examples of inventive aspects implemented in accordance with the principles of the disclosure;

FIG. 16 is a block diagram of an example navigational user interface in which content navigation can be implemented through tap-based communication in accordance with the principles of the disclosure;

FIG. 17 is a diagram of an example navigational user interface in which content navigation can be implemented through gestures in accordance with the principles of the disclosure;

FIG. 18 is a schematic diagram of an example zone layout used by the navigational user interface of FIG. 17 to process the movement of the tapping implement in accordance with the principles of the disclosure;

FIG. 19 is a flowchart illustrating an operational flow for an example determine process by which a navigational user interface ascertains and interprets a gesture-based navigational instruction in accordance with the principles of the disclosure;

FIG. 20 is a schematic diagram of an example zone layout used by a navigational user interface to process the movement of the tapping implement in accordance with the principles of the disclosure;

FIG. 21 is a flowchart illustrating an example accelerated scrolling process by which a user can cycle quickly through display elements representing available categories to select a new category to access in accordance with the principles of the disclosure;

FIG. 22 is an example navigational user interface having features that are examples of inventive aspects implemented in accordance with the principles of the disclosure;

FIG. 23 is a schematic block diagram of an example navigational user interface configured in an inverted navigation state in accordance with the principles of the disclosure;

FIGS. 24A and 24B illustrate a navigational user interface having features that are examples of inventive aspects implemented in accordance with the principles of the disclosure; and

FIG. 25 is an example navigational user interface having features that are examples of inventive aspects implemented in accordance with the principles of the disclosure.

### DETAILED DESCRIPTION

Embodiments of the present disclosure are directed to a navigational user interface for displaying content data and services stored, e.g., on a mobile electronic device. Other aspects relate to navigating through the navigational user interface on the mobile device to access and display the content data and services. The described navigational user interface is applicable to mobile devices (e.g., handheld computing devices), but may be applied to other computing devices as appropriate.

Content data on mobile devices can take many forms including, but not limited to, contact information, calendar items, email messages, voicemail recordings, music, photos, documents, and tasks or actions. Mobile device services can include telephone services, email services, text messaging services, music play, and the like. The user interface generally arranges the content data onto content pages, which are organized under content categories (e.g., messages, contacts, tools, and settings). In one embodiment, each content category is associated with a software application appropriate for processing the content data (e.g., plug-in type applications). Within each content category, a user can traverse through content pages, which include full screen displays within which action items and/or content data are arranged.

The term “action item” as used in this application encompasses any specific content on a content page with which a user may interact. Action items also may be referred to as selectable objects or elements. Upon navigation to an action item, a user may “select” that action item, thereby causing an action to occur. Examples of action items include, among others, hyperlinks, images, embedded content pages, and interface elements, such as, buttons, text boxes, drop-down menus, etc. Action items may lead to displays enabling a user to implement services, such as phone, email, or text messaging services.

A navigational user interface having features that are examples of inventive aspects in accordance with the principles of the present disclosure enables a user to navigate through content pages and content categories regardless of what content data is currently being displayed to the user. For example, the navigational user interface includes a category input and a page input. The category input cycles through the categories to enable a user to select a new category, thereby providing access to the pages organized under the newly selected category. The page input cycles through the pages organized under the selected category to sequentially display the pages. The category input and the page input each can be selected regardless of what page is currently displayed to the user.

In certain embodiments, the navigational user interface receives input from a screen display. In such cases, the navigational user interface can provide touch support implemented with a tap system and/or a gesture system as will be described herein. By implementing a combination of both tap- and gesture-based systems, the navigational user interface will improve user experience by enabling gesture-based communication, while still accommodating users who prefer tap-based communication.

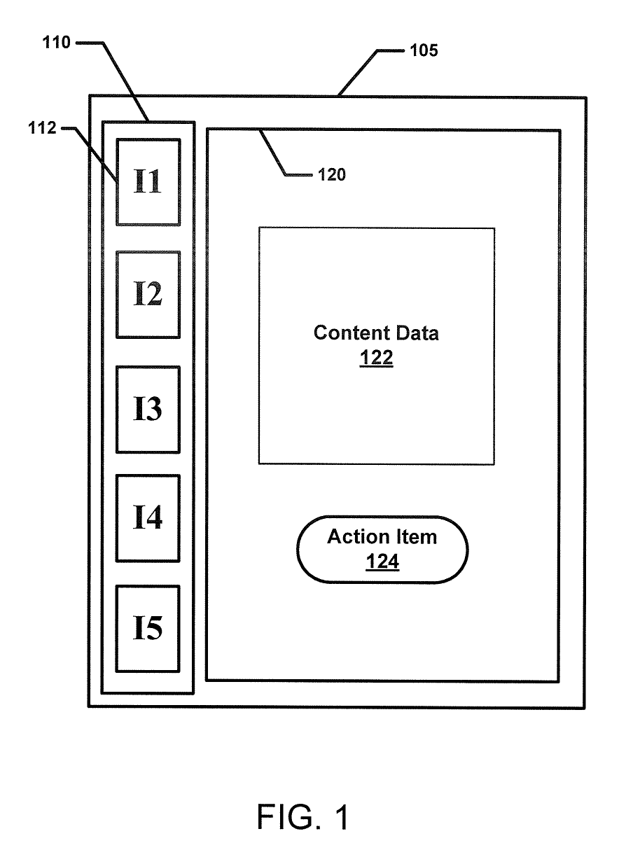

FIG. 1 shows a schematic diagram of an example navigational user interface 100 within which a user can access stored content data and available services on an electronic device. In general, the navigational user interface 100 includes a navigation bar 110 and a content panel 120. The navigation bar 110 includes indicia 112 representing available categories that are selectable by the user. When a category is selected, content pages associated with the category can be individually displayed within the content panel 120. Each content page can include content data (e.g., email message text, photographs, musical selections, etc.) 122 and/or action items 124.

In general, the content panel 120 extends over a substantial portion of the navigational user interface 100. For example, in different embodiments, the content panel 120 can extend over an area ranging from about 20% to about 100% of the navigational user interface 100. Preferably, the navigation bar 110 is arranged adjacent the content panel 120 over a substantially smaller portion of the navigational user interface 100 than the content panel 120. For example, the navigation bar 110 can extend over a side of the user interface 100 as shown in FIG. 1. In other embodiments, however, the navigation bar 110 can extend over any desired portion (e.g., top, bottom, center, etc) of the navigational user interface 100.

Display elements 112 (e.g., icons) can be arranged within the navigation bar 110. Each display element 112 represents a category available to the user for selection. In some embodiments, display elements 112 of only a subset of the available categories are visible on the navigation bar 110 at any given time. As will be discussed in greater detail herein, the user can scroll (i.e., cycle) through the display elements 112 of the navigation bar 110 to view the remaining display elements 112. In some embodiments, the navigation bar 110 is differentiated from a background of the user interface 100. In other embodiments, however, only the display elements 112 arranged on the navigation bar 110 are distinguished from the background.

Example categories that can be represented on the navigation bar 110 include, but are not limited to, email, contacts, settings, and media. In some embodiments, one or more of the categories correspond with software applications (e.g., plug-in-type applications) providing access to and optionally enabling manipulation of specific types of content data. Examples of software applications include, inter alia, email programs, scheduling programs, PIM (personal information management) programs, word processing programs, spreadsheet programs, and Internet browser programs. For example, an email program can enable a user to create, send, and view email messages. A media editor may enable viewing, editing, and/or sorting of still images and/or videos.

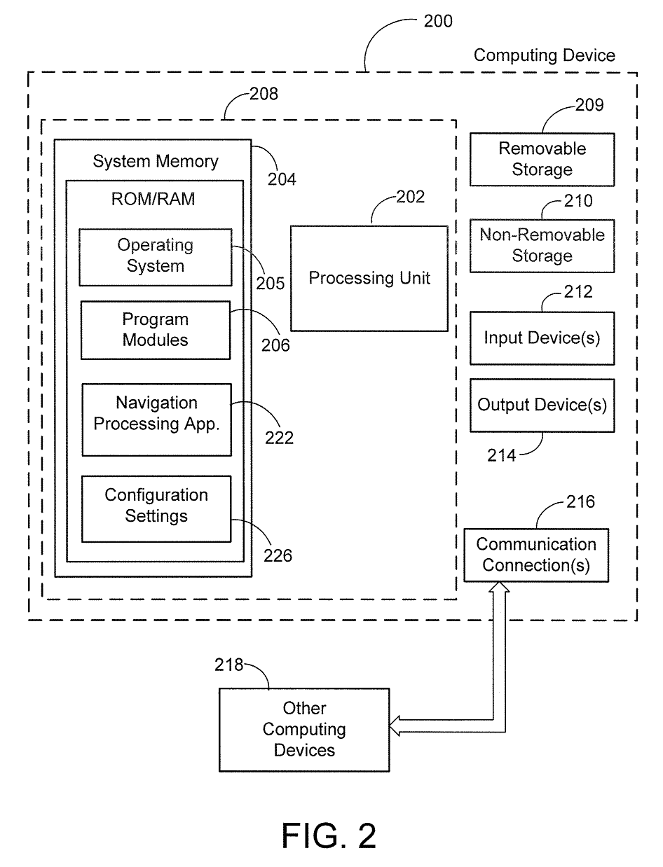

FIG. 2 and the associated discussion are intended to provide a brief, general description of a suitable computing environment in which embodiments of the navigational user interface 100 may be implemented. With reference to FIG. 2, a block diagram of an example computing operating environment is illustrated, such as computing device 200. In a basic configuration, the computing device 200 may be a mobile device (e.g., a mobile phone) or a stationary computing device with a limited-capability display.

Computing device 200 may typically include at least one processing unit 202 and system memory 204. Computing device 200 may also include a plurality of processing units that cooperate in executing programs. Depending on the exact configuration and type of computing device, the system memory 204 may be volatile (such as RAM), non-volatile (such as ROM, flash memory, etc.) or some combination of the two.

An operating system 205 suitable for controlling the operation of a networked personal computer, such as the WINDOWS® operating systems from MICROSOFT CORPORATION of Redmond, Wash., is typically stored in system memory 204. The system memory 204 also may include configuration settings 226 and one or more software applications, such as program modules 206 and navigation processing application 222. The navigation processing application 222 obtains user input (e.g., via input device 212), ascertains a navigational instruction from the user input, and executes the navigational instruction to change which content data or services are presented to the user.

Computing device 200 may have output device(s) 214, such as a display (e.g., a screen), speakers, external printer, etc. The computing device 200 also may have input device(s) 212, such as a D-pad, jog-wheel, hardware buttons, soft keys, keyboard, pen, voice input device, touch input screen, external mouse, etc. These devices are well known in the art and need not be discussed at length here. In some embodiments, navigational instructions can be hardwired into certain input devices 212. In other embodiments, navigational instructions can be associated with input devices 212 via software. For example, a user can view and select navigation indicia 126 presented on the display 214 of the computing device 200.

The computing device 200 also may have additional features or functionality. For example, the computing device 200 may also include additional data storage devices (removable and/or non-removable). Such additional storage is illustrated in FIG. 2 by removable storage 209 and non-removable storage 210. Computer storage media may include volatile and nonvolatile, removable and non-removable media implemented in any method or technology for storage of information, such as computer readable instructions, data structures, program modules, or other data. System memory 204, removable storage 209, and non-removable storage 210 are all examples of computer storage media. Computer storage media includes, but is not limited to, RAM, ROM, EEPROM, flash memory or any other medium which can be used to store the desired information and which can be accessed by computing device 200. Any such computer storage media may be part of device 200.

The computing device 200 also may contain communication connections 216 that allow the device to communicate with other computing devices 218, such as over a wireless network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

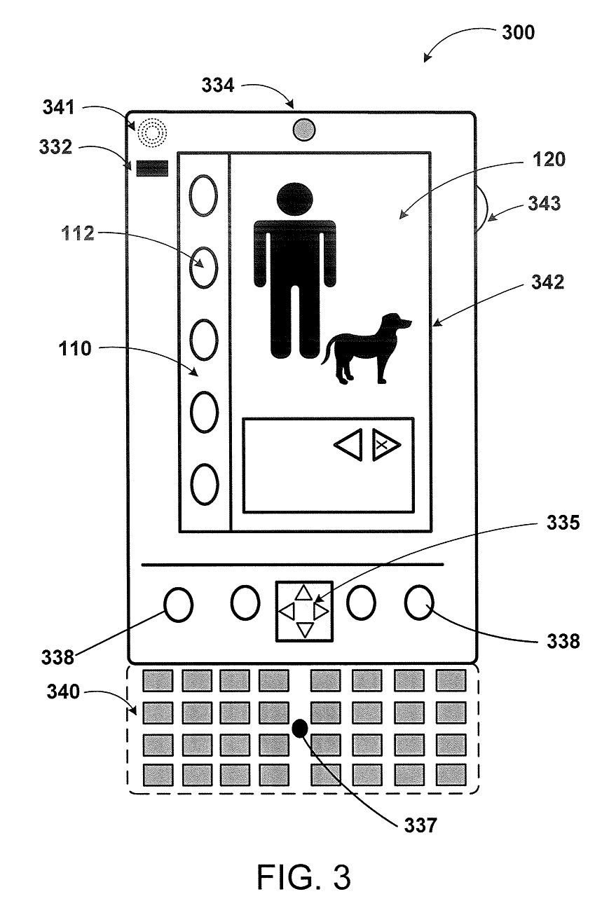

FIG. 3 illustrates an example mobile electronic device 300 providing the computing environment 200 on which the navigational user interface 100 can be implemented to provide access to content data and available services. Mobile device 300 may be any portable (or stationary) computing device with a display that is typically smaller in size, thereby limiting the amount of information that can be displayed intelligibly. In FIG. 3, the mobile device 300 displays a content page 122 within the content panel 120 of the navigational user interface 100. A navigation bar 110 and navigational indicia 126 also are visible.

Mobile device 300 is shown with many features. However, embodiments of the mobile device 300 may be implemented with fewer or additional components. The example mobile device 300 shown in FIG. 3 includes typical components of a mobile communication device, such as a hard keypad 340, specialized buttons (“function keys”) 338, display 342, speaker 341, and one or more indicators (e.g. LED). Mobile device 300 may also include a camera 334 for video communications and microphone 332 for voice communications.

Mobile device 300 also can include navigational input features including a D-pad 335, a jog-wheel 343, a track ball 337, and an interactive (e.g., touch sensitive) display 342. The display 342 also may provide soft key options. Touch sensitive displays receive input through some form of tapping implement (e.g., stylus, finger, etc.) that is tapped and/or dragged across the display. Typically, the display 342 is a relatively small sized display screen. In addition, due to space and available power constraints, certain capabilities (resolution, etc.) of the display 342 may also be more limited than those of a traditional large display. A user navigation interface displaying the available options or content data within such a display may become cluttered. Accordingly, a user navigation interface, such as user navigation interface 100, facilitating access to options and content data is advantageous.

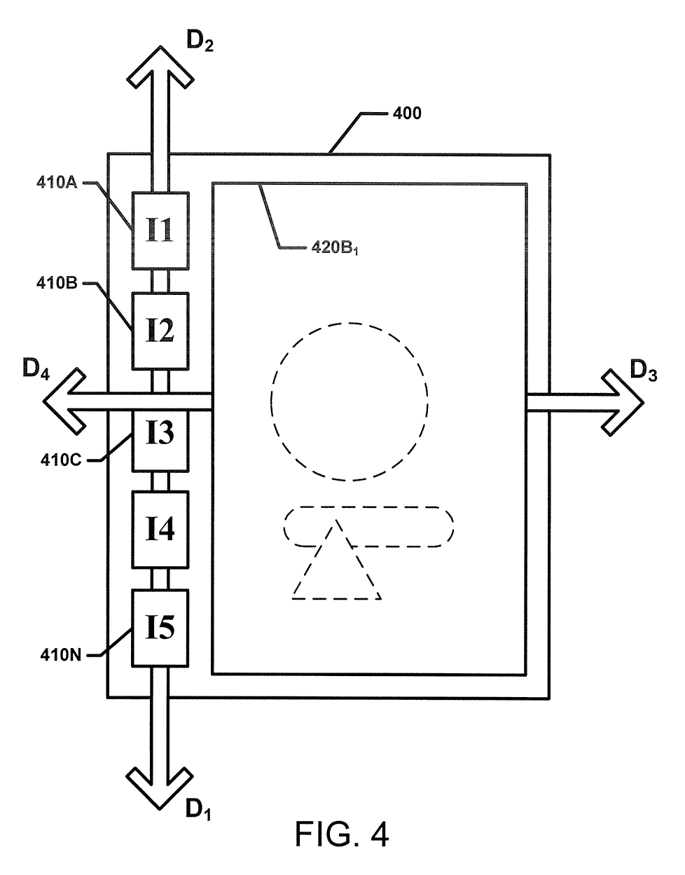

Referring to FIG. 4, to navigate amongst the categories and content pages within the navigational user interface, a user may select one of multiple navigational directions. The navigational directions are generally divided into two sets: (1) a category traversal set; and (2) a page traversal set. In one embodiment, the user selects from four navigational directions (e.g., up, down, left, and right). One direction in each set increments the chosen set and one direction in each set decrements the chosen set.

For example, selection of one of the navigational directions in the category traversal set changes which category is currently accessed, regardless of what content data is currently being displayed. Selection of one of the navigational directions of the page traversal set sequentially traverses the content pages associated with the accessed category, regardless of what content data is currently displayed to the user. Typically, each traversal set includes two directions. In one embodiment, each set of navigational directions includes two opposing navigational directions (e.g., up and down).

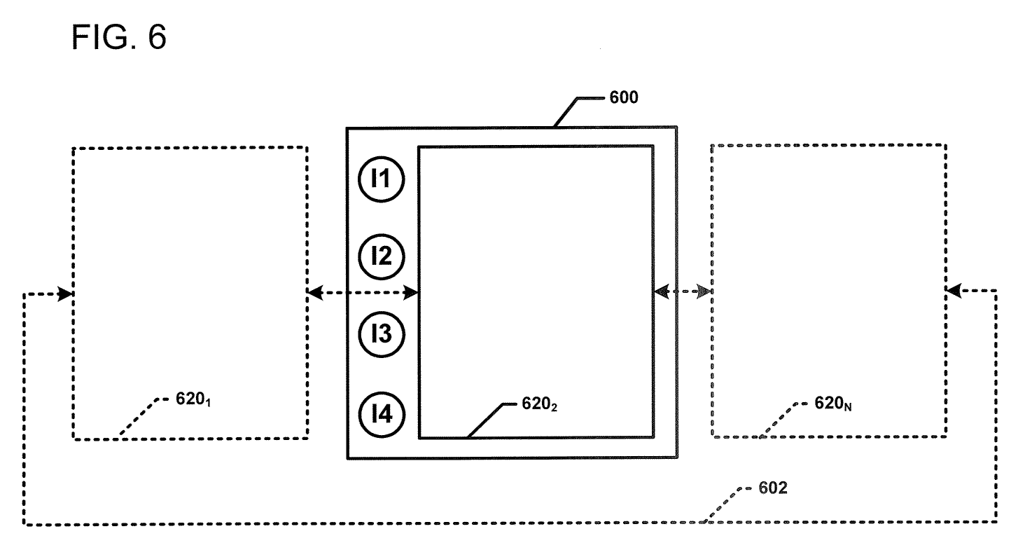

FIG. 4 is a schematic diagram of navigational flow paths 400 through content data stored on an electronic device, such as electronic device 300. The navigational flow paths 400 facilitate navigating through categories 410 and through the content pages 420 within each category 410. Generally, the navigational flow paths follow navigational directions D₁, D₂, D₃, and D₄. The categories 410 are generally organized in a first sequence from a first category 410A to a last category 410N. Within each category 410, content pages 420 are organized in a second sequence from a first content page (e.g., see page 620₁ of FIG. 6) to a last content page (e.g., see page 620_{N} of FIG. 6).

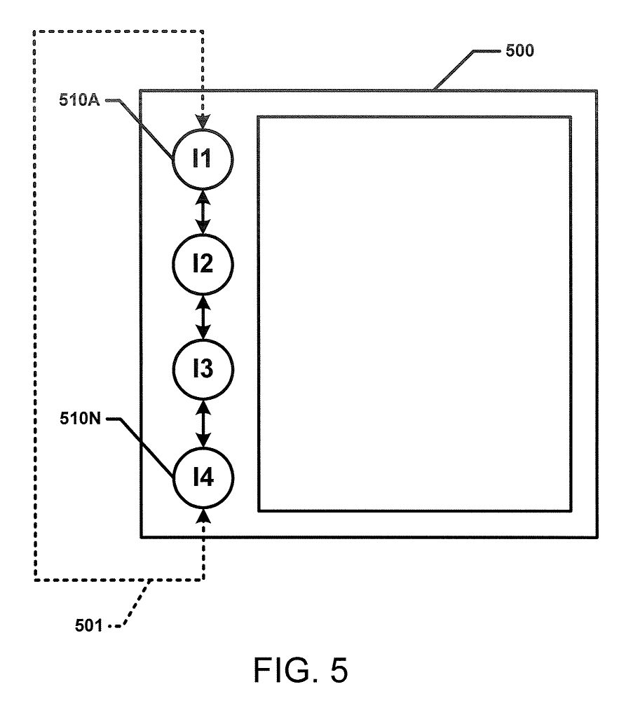

As shown in FIGS. 5 and 6, the flow paths 400 connecting the categories 410 and/or pages 420 can be arranged in loops, allowing a user to cycle through the categories 410 and/or pages 420 continuously until making a selection. In such embodiments, incrementing categories 410 and/or pages 420 refers to cycling through the looped flow paths 400 in a first direction and decrementing categories 410 and/or pages 420 refers to cycling through the looped flow paths 400 in a second, opposite direction. As the term is used herein “cycling” refers to sequentially selecting one of multiple categories and or one of multiple pages. In one embodiment, only one category and one page can be selected at any given time.

FIG. 5 is a schematic diagram of a user interface 500 having features that are examples of inventive aspects in accordance with the principles of the present disclosure. In FIG. 5, a user can follow a navigational flow path 501 from the final category 510N back to the first category 510A. The navigational flow path 501 also can lead from the first category 510A back to the final category 510N. FIG. 6 is a schematic diagram of another user interface 600 having features that are examples of inventive aspects in accordance with the present disclosure. In FIG. 6, a user can follow a navigational flow path 602 from the final page 620N back to the first page 620A. The navigational flow path 602 also can lead from the first page 620A back to the final page 620N.

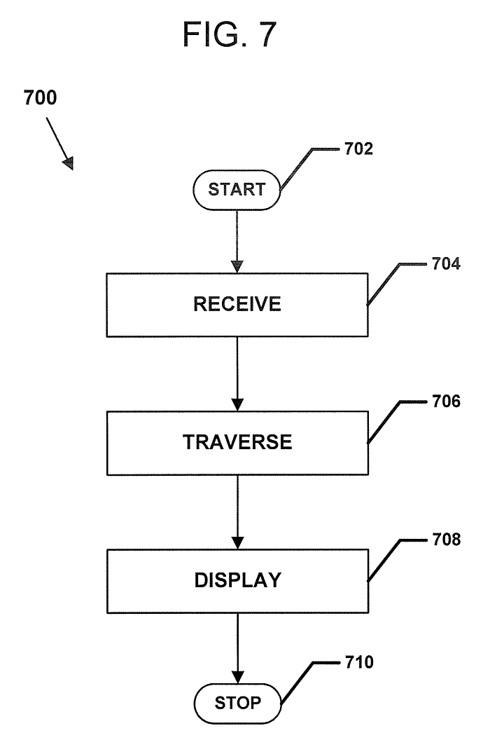

FIG. 7 is a flowchart illustrating an operational flow for an example navigation process 700 for navigating through content data on an electronic device, such as electronic device 300. The navigation process 700 initializes and begins at a start module 702 and proceeds to a receive operation 704. The receive operation 704 obtains indicia indicating a traversal direction chosen by the user. For example, the receive operation 704 can obtain one of traversal directions D₁, D₂, D₃, and D₄.

A traverse operation 706 navigates through the content data in accordance with the received traversal direction. For example, if the traversal direction indicates categories, should be incremented, then access operation 708 will access the next category in the sequence and will display the default page associated with that category. Alternatively, if the traversal direction indicates the navigational user interface should decrement a content page, then access operation 708 will access the content page prior in the sequence. A display operation 708 displays the content data to which the user navigated. The navigation process 700 completes and ends at a stop module 710.

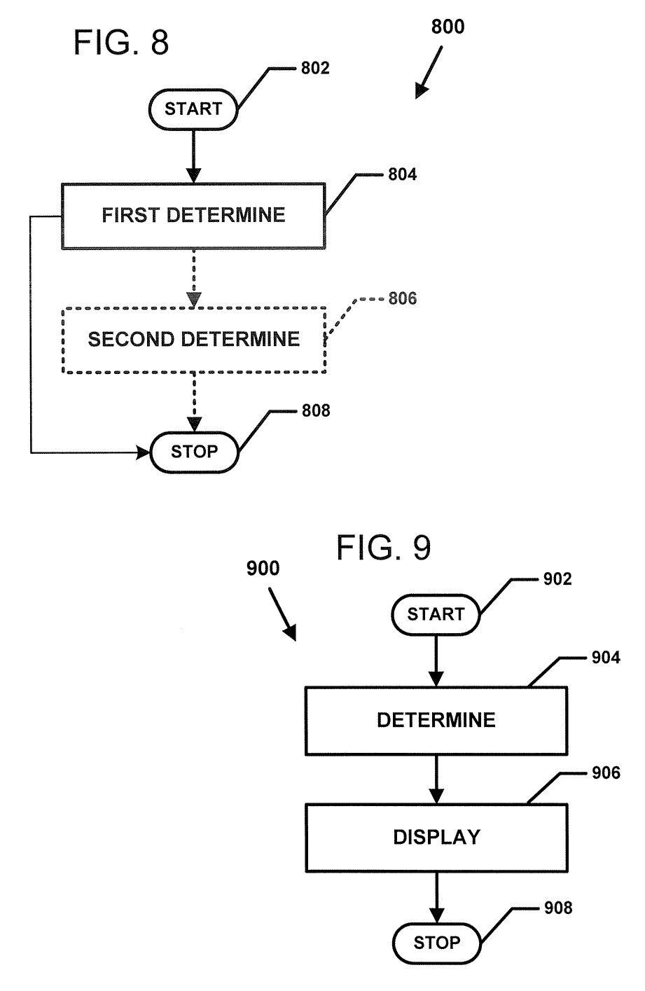

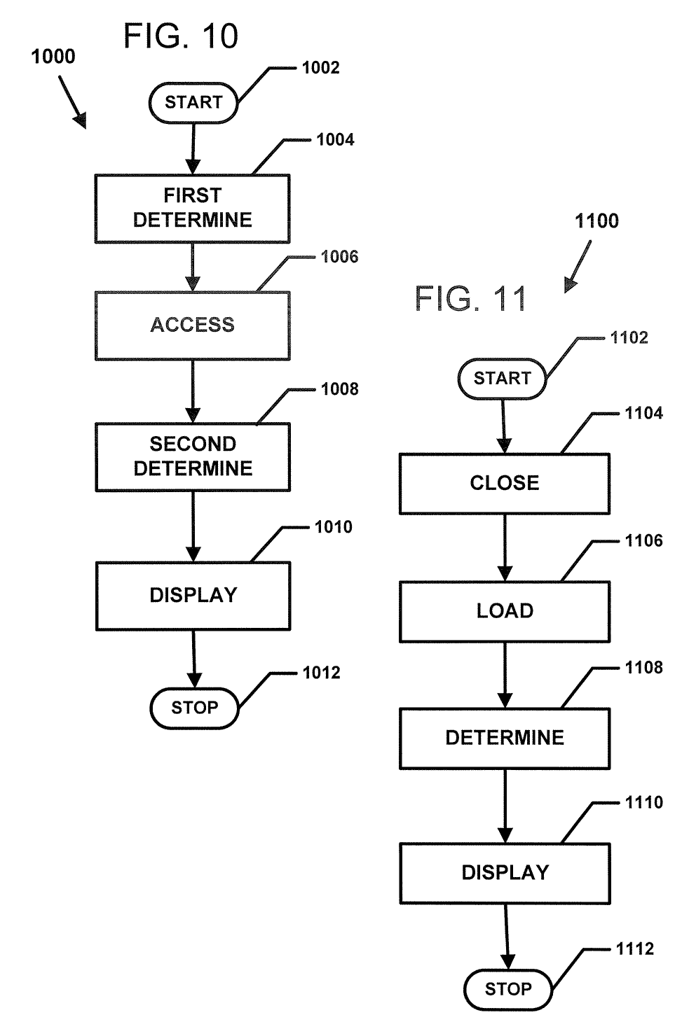

FIGS. 8-10 are flowcharts illustrating example operational flows for implementing the operations of the navigation process 700. FIG. 8 illustrates an operational flow for an ascertain process 800 for implementing the receive operation 704. FIGS. 9 and 10 illustrate different operational flows for traversal processes 900, 1000, respectively, for implementing the traverse operation 706 of the navigation process 700.

The ascertain process 800 of FIG. 8 initializes and begins at a start module 802 and proceeds to a first determine operation 804. The first determine operation 804 determines the type of traversal direction. In one embodiment, the first determine operation 804 ascertains whether the received traversal direction is a category traversal direction or a page traversal direction. An optional second determine operation 806 determines whether the traversal direction indicates an incremental direction or a decremental direction. Alternatively, the navigational user interface can cycle in only one direction. The ascertain process 800 completes and ends at a stop module 808.

The traversal process 900 of FIG. 9 can be executed to implement the traverse operation 706 of the navigation process 700 when the traversal direction is a page traversal direction. The traversal process 900 initializes and begins at a start module 902 and proceeds to a determine operation 904. The determine operation 904 obtains the next content page in the sequence of content pages in the currently selected category. A display operation 906 renders the next content page and presents the rendered page to the user, e.g., via the navigational user interface. The traversal process 900 completes and ends at a stop module 908.

The traversal process 1000 of FIG. 10 is executed to implement the traverse operation 706 of the navigation process 700 when the traversal direction is a category traversal direction. The traversal process 1000 initializes and begins at a start module 1002 and proceeds to a first determine operation 1004. The first determine operation 1004 determines which category is next in the sequence of categories. An access operation 1006 determines what content pages are associated with the next category. For example, the access operation 1006 can determine an array or linked list of content pages associated with the category. A second determine operation 1008 ascertains which of the associated content pages is a default page. A display operation 1010 renders the default page and presents the rendered page to the user, e.g., via the navigational user interface. The traversal process 1000 completes and ends at a stop module 1012.

For example, in FIG. 4, a first category 410B is selected and a content page 420B₁ associated with the first category 410B is displayed. Selection of a first category traversal direction (e.g., down) D₁ accesses a second category 410C that is arranged next in the sequence of categories 410. A default content page associated with the second category 410C is displayed when the second category 410C is accessed. Alternatively, selection of a second category traversal direction (e.g., up) D₂ when the first category 410B is selected, accesses a third category 410A that is arranged prior to the first category 410B in the sequence of categories 410. A default content page associated with the third category 410A is displayed when the third category 410A is accessed.

In certain embodiments, the categories 410 include software applications (e.g., plug-in type software applications) configured to process the content data organized under the respective categories. For example, the categories 410 may include an email program, a text messaging program, and a music player program. In such embodiments, choosing to navigate in the one of the category traversal directions sequentially closes, loads, and executes the software applications as well as the respective content data.

FIG. 11 is a flowchart illustrating an operational flow for an example software traversal process 1100 for navigating through software applications on an electronic device, such as electronic device 300. The software traversal process 1100 initializes and begins at a start module 1102 and proceeds to a close operation 1104. The close operation 1104 exits out of the software application currently executing when the navigation instruction is received. A load operation 1106 determines the next software application in the sequence and loads that software application. A determine operation 1108 determines the default content page associated with the software application. For example, the determine operation 1108 may discover a content page listing a menu of functionalities of the software application. A display operation 1110 presents the default content page to the user. The traversal process 1100 completes and ends at a stop module 1112.

For example, to access email capabilities, a user navigates to and opens an email application. A default content page associated with the email application is displayed to the user in the content panel. The user then navigates through content pages to obtain access to action items (e.g., a link to an internal phonebook or a message inbox) and/or content data (e.g., phonebook listings, email messages, etc.).

In one embodiment, the user can navigate to a content page associated with an email editor and select an action item on the page. Selection of the action item opens an email template within the content panel. The user may enter information, such as a textual message, recipient contact information, a subject line, and/or message attachments, into the email template within the content panel.

In another embodiment, the user navigates to the content page associated with the user's inbox and selects an action item on the page. Selection of the action item opens the inbox, which can contain messages organized into a series of one or more content pages. The user views different messages by navigating through the series of content pages by sequentially displaying each content page within the content panel.

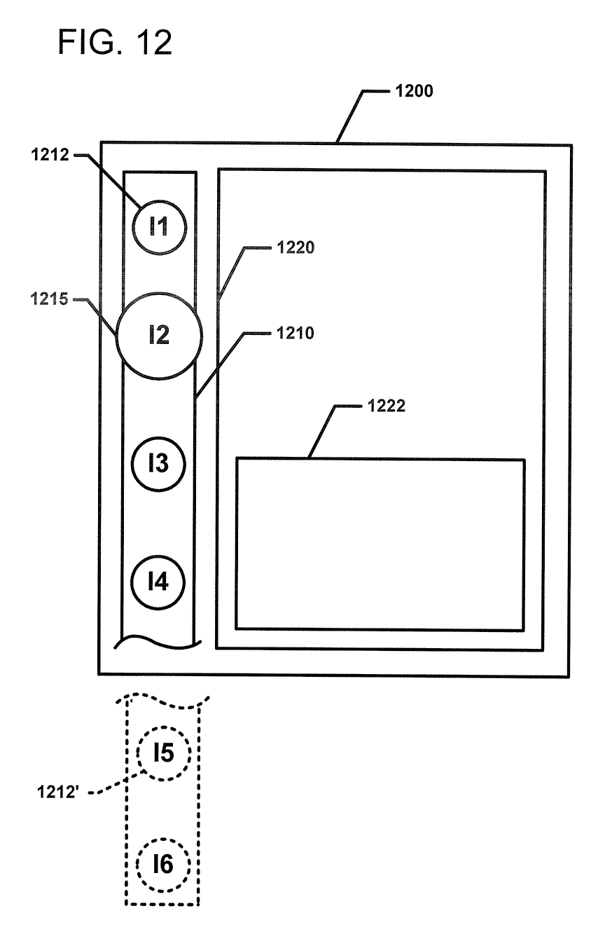

Referring to FIG. 12, an exemplary navigational user interface 1200 having features that are examples of inventive aspects in accordance with the principles of the present disclosure is shown. The navigational user interface 1200 includes a navigation bar 1210 and a content panel 1220. Content data 1222 is displayed within the content panel 1220. The navigation bar 1210 displays icons or other display elements 1212 representing categories available for selection. In one embodiment, the selected category is differentiated in the navigation bar 1210 from the remaining categories. For example, as shown in FIG. 12, an enlarged display icon 1215 can represent the selected category.

In some embodiments, only a subset of the available categories is visible on the navigation bar 1210 at any one time. For example, display icons 1212′ are not visible on the navigation bar 1210 in FIG. 12. However, when a user cycles through the available categories, visible display icons 1212 scroll off the navigation bar 1210 and non-visible display icons 1212′ can scroll onto the navigation bar 1210. If the categories are arranged along a looped flow path, then continuing to increment past the final category will cycle the first category back onto the navigation bar 1210.

In certain embodiments, the user interface 1210 can have an acceleration mode. When configured in such a mode, the navigational user interface 1200 enables a user to cycle quickly through the available categories and/or pages without rendering and displaying the content data associated with each sequential page. The content data is only rendered and displayed after a category and/or page is chosen.

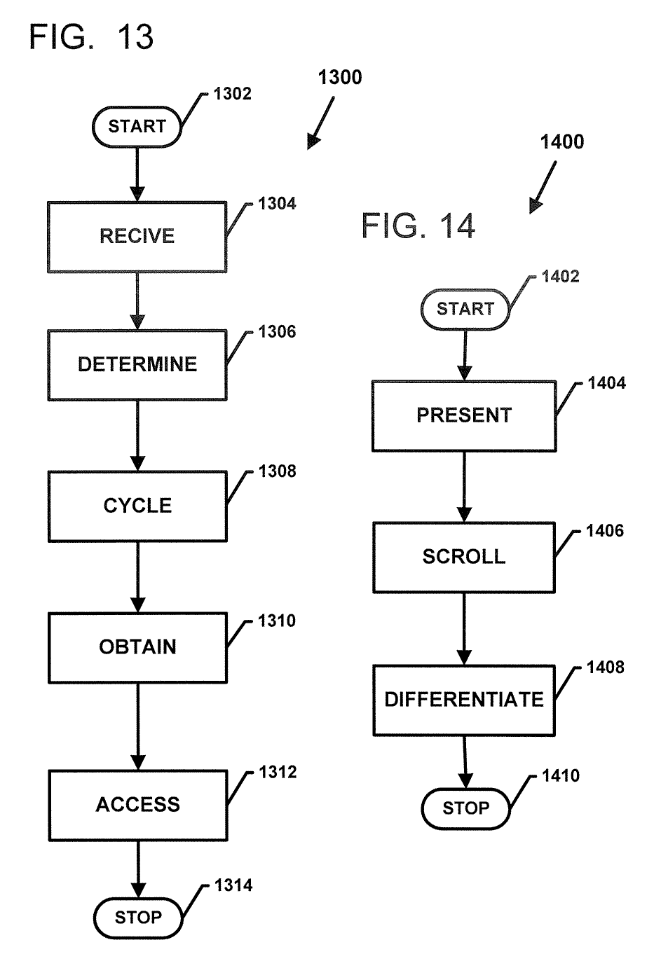

FIG. 13 is a flowchart illustrating an operational flow for an example cycling process 1300 by which a category may be selected quickly. The cycling process 1300 initializes and begins at a start module 1302 and proceeds to a receive operation 1304. The receive operation 1304 obtains a navigation instruction indicating the user interface should enter acceleration mode. A determine operation 1306 ascertains which traversal type (e.g., category or page) is indicated by the received navigation instruction. The determine operation 1306 optionally determines which cycle direction (e.g., increment or decrement) is indicated by the navigation instruction.

A cycle operation 1308 traverses through the categories in the sequence of categories until a stop instruction is received at an obtain operation 1310. In one embodiment, the obtain operation 1310 receives an affirmative instruction to stop cycling (e.g., tapping an input key). In another embodiment, however, the obtain operation 1310 determines when the navigational instruction received by the receive operation 1304 is no longer received (e.g., lifting up on an input key after depressing the input key for an extended period of time).

The cycle operation 1308 does not access each category through which it cycles. Rather, an access operation 1312 accesses only the category that is eventually selected when the stop instruction is received. Access operation 1312 determines a default page associated with the selected category and displays the default page. The cycling process 1300 completes and ends at a stop module 1314.

FIG. 14 is a flowchart illustrating an operational flow for an example display process 1400 for indicating when the navigational user interface is implementing accelerated cycling. The display process 1400 initializes and begins at a start module 1402 and proceeds to a present operation 1404. The present operation 1404 displays a consistent image within the content panel 1220 of the user interface 1200 while the user is cycling through the category options. For example, the present operation 1404 can display a particular content page while cycling. Alternatively, the present operation 1404 may refrain from displaying a content page and allow the background of the navigational user interface 1200 to show through.

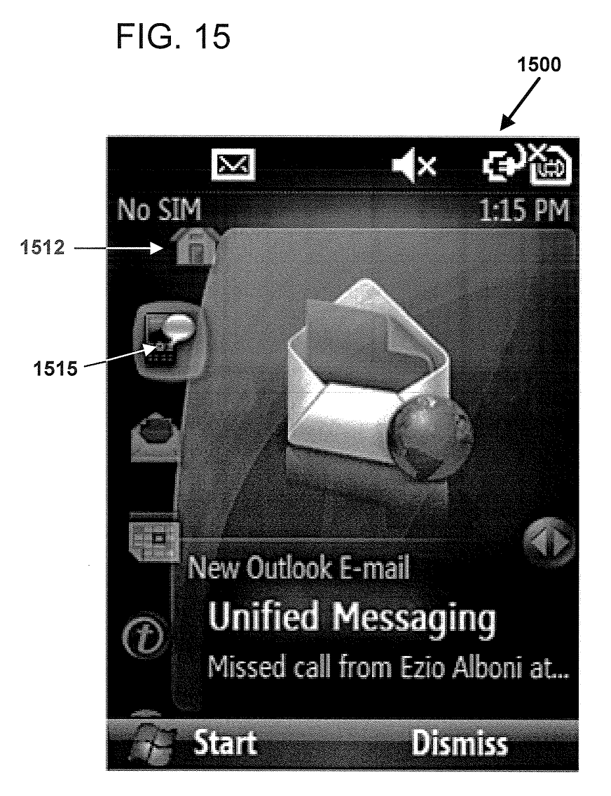

A cycle operation 1406 scrolls through display elements 1212 in the navigation bar 1210 that represent the available categories. As the user cycles through the categories, a differentiate operation 1408 indicates the current category available for selection. For example, the differentiate operation 1408 can enlarge, color, outline, or otherwise distinguish a display element 1212 representing the current category. In the example shown in FIG. 15, the selected display element 1212 is enlarged, colored, and shadowed. In one embodiment, an animation of the display elements 1212 scrolling across the navigation bar 1210 is presented to the user while the user is cycling through categories.

In another embodiment, however, the display elements 1212 remain in place with respect to the navigation bar 1210. Instead, the differentiate operation 1408 sequentially distinguishes the display elements 1212 while the categories are cycled. For example, in such an embodiment, decrementing categories on the interface 1500 shown in FIG. 15 would cause the differentiate operation 1408 to shrink the phone icon 1515 and to enlarge the envelope icon 1512. The differentiate operation 1408 also could darken the phone icon to the same degree as the remaining icons and brighten the colors of the envelope icon. The display process 1400 completes and ends at a stop module 1410.

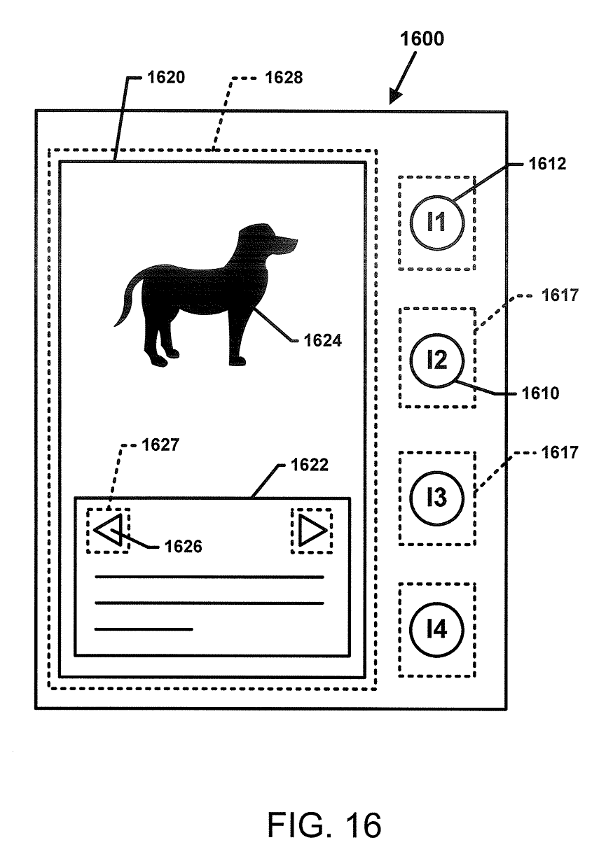

Referring to FIGS. 16-25, in some examples, the navigational user interface can receive input from a touch-sensitive display. In such cases, the navigational user interface can provide touch support implemented with a tap system and/or a gesture system as will be described herein. By using a combination of both tap- and gesture-based systems, embodiments of the navigational user interface may improve the user experience by enabling gesture-based communication, while still accommodating users who prefer tap-based communication.

In tap-based communication, a user interacts with the navigational user interface by tapping on different sections of the touch screen. For example, FIG. 16 is a block diagram of an example navigational user interface configured to accept and process tap- and gesture-based communication. As shown in FIG. 16, the user can: a) tap a navigation bar display element 1612, b) tap navigation indicia 1626 displayed within the content panel 1620, and/or c) tap an action items 1624 within the content panel 1620.

To support tapping on a display element 1612 of the navigation bar 1610, an area 1617 over each display element 1612 is defined as a tap area. In general, when the interface framework identifies a tap anywhere within the tap area 1617, the interface framework will navigate immediately to the category (e.g., plug-in application) associated with the tap area 1617. Tap areas 1617 follow their corresponding display elements 1612 when the display elements 1612 scroll along the display screen.

Typically, tap areas 1617 extend beyond the corresponding display elements 1612 without overlapping one another. This extra area facilitates tapping by reducing the need for accuracy. In certain embodiments, the tap area 1617 is arranged in a square pattern centered on the display element 1612. In one embodiment, the tap area 1617 is less than or equal to about fifty-five pixels by fifty-five pixels.

To further provide tap-based communication, navigational indicia 1626 enable a user to navigate through content pages via a tap action. In general, the navigational indicia 1626 function to increment and decrement the content page displayed to the user. An area 1627 over each navigation indicia 1626 is defined as a tap area. When the interface framework identifies a tap anywhere within the tap area 1627 of one of the navigation indicia 1626, the interface framework will navigate immediately to the next or previous content page as appropriate.

When the content pages are arranged along a looped flow path, the navigation indicia are always visible (as there is always a page to navigate to in both directions). In other embodiments, the content pages are arranged in linear arrays. In such embodiments, increment and decrement indicia 1626 are shown as appropriate. In certain embodiments, the navigational indicia 1626 also can inform users of new and/or special events (e.g., through a glowing action). In one embodiment, if content has been updated, these indicia 1626 can flash to indicate a direction in which the user should navigate to reach the new content. For example, increment indicia 1626 can flash when a new email message is received to inform the user that navigating in an incremental direction will display the new email message.

The navigational user interface 1600 also is configured to enable tapping on the content panel 1620 and/or the action items 1624 within the content panel 1620. In some embodiments, tapping on the display of the navigational user interface 1600 anywhere except for near the navigation bar 1610 or navigation icons 1626 selects the entire content panel 1620. In other embodiments, however, the user can separately select action items 1624 and/or content 1622 within the content panel 1620.

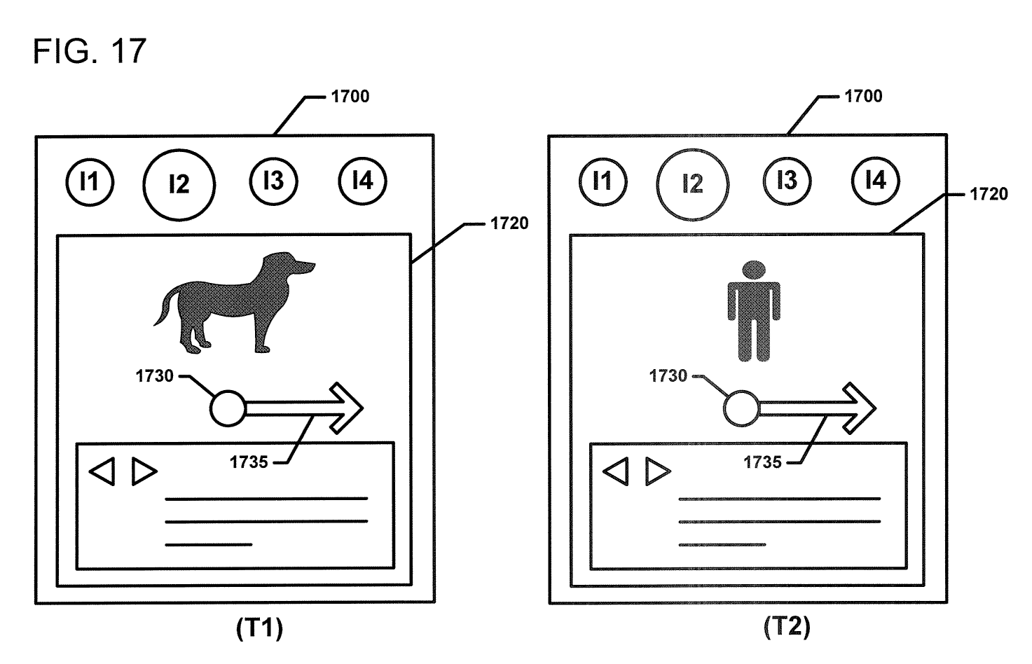

Referring to FIGS. 17-22, gesture support facilitates navigation between categories and content pages without searching for and identifying specific areas on which to tap. Gesture-based communication is advantageous when attempting to navigate through large, rich content with only relatively small tap areas being available. By recognizing basic gestures, a user interface touch system can emulate the tap-based navigation system, while facilitating intuitive navigation through the content data.

In general, gesture-based communication includes tapping motions and dragging motions. The navigational user interface processes movement of a tapping implement (e.g., a finger, a stylus, a light pen, etc.) to determine whether a gesture was made and to ascertain the navigational instruction indicated by the gesture. The navigational instruction indicates a type of navigation (i.e., category or page) and a navigational direction. The direction of navigation is generally based on the direction of the dragging motion.

For example, a first direction of drag can be associated with incremental category navigation and a second direction of drag can be associated with decremental category navigation. Typically, the first direction extends opposite the second direction. A third direction of drag can be associated with incremental page navigation and a fourth direction of drag can be associated with decremental page navigation.

Gesture-based communication implemented in accordance with the principles of the present disclosure can include at least two different types of gestures: a) basic navigation gestures; and b) navigation bar gestures. The former facilitates navigation through categories and content pages. The latter facilitates accelerated navigation between categories. Typically, basic navigation gestures are initiated by tapping anywhere on the display, except the navigation bar. Navigation bar gestures are initiated by tapping on the navigation bar.

For example, FIG. 17 is a diagram of an example navigational user interface 1700 in which content navigation can be implemented through gestures. An example basic navigation gesture is illustrated in FIG. 17. A circle 1730 indicates a tap area (i.e., area of the touch screen contacted by the tapping implement) and an arrow 1735 represents a drag gesture. In FIG. 17, the arrow 1735 indicates the tapping implement is dragged towards the right of the interface 1700. Each of these basic navigation gestures sequentially cycles either the category or the content page once.

In the example shown in FIG. 17, the right side of the display is defined as an incremental, page traversal direction. Therefore, when the tapping implement is dragged to the right side of the display, the content page displayed in the content panel 1720 of the interface 1700 is cycled to the next content page associated with the currently selected category (e.g., the category represented by icon 12). In FIG. 17, the content page displaying a picture of a dog at a time Ti is removed from the display screen and the next content page displaying a picture of a person is displayed at a later time T2.

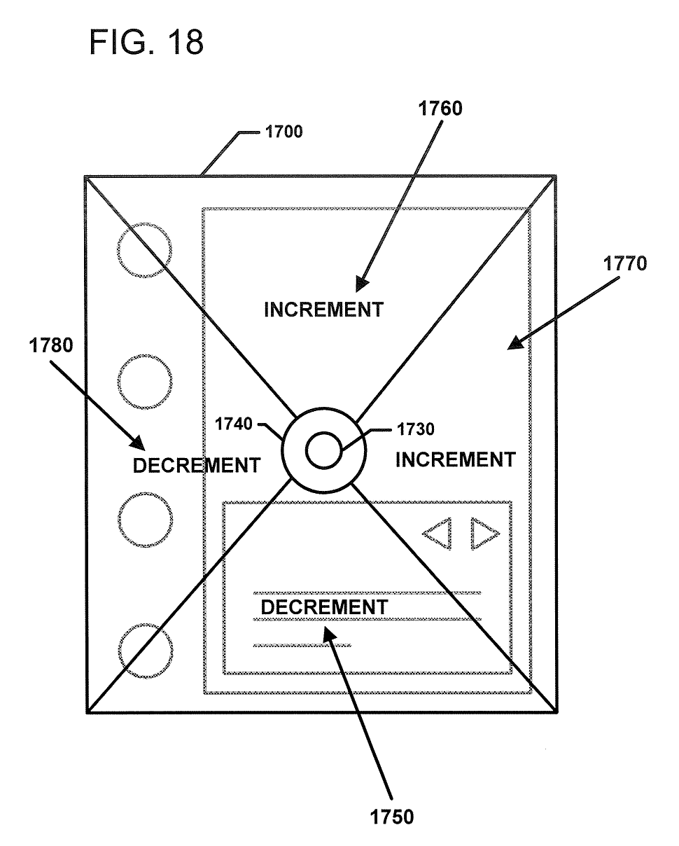

FIG. 18 is a schematic diagram of an example zone layout used by the navigational user interface 1700 to process the movement of the tapping implement. In general, the navigational user interface 1700 interprets movement of the tapping implement based on the start position of the tap and a zone into which the tapping implement is dragged.

In FIG. 18, the display area of the user interface 1700 is sectioned into five zones 1740, 1750, 1760, 1770, 1780 based on the location at which the tap portion of the gesture is performed. Each of the zones is associated with a different navigational instruction. For example, the first zone 1740 can be associated with a “just tap” instruction; the second zone 1750 can be associated with an increment categories instruction; and the third zone 1760 can be associated with a decrement categories instruction. The fourth and fifth zones 1770, 1780 can be associated with increment and decrement page instructions, respectively. In other embodiments, however, each zone can be associated with any desired navigational instruction.

Four of these zones 1750, 1760, 1770, 1780 are generally formed by splitting the display area of the navigational user interface 1700 into four areas centered on the original tap point 1730. In one embodiment, the zones 1750, 1760, 1770, 1780 are defined by four triangular areas of approximately equal area. In another embodiment, the area of each zone 1750, 1760, 1770, 1780 can differ from the other areas. A fifth zone 1740 includes an area overlaying and surrounding the tap location 1730. For example, the fifth zone 1740 can include a circular area extending outwardly from the tap location 1730. In one embodiment, the circular area of the fifth zone 1740 has about a twenty pixel radius.

In general, providing the “just tap” zone 1740 inhibits the accidental selection of a gesture-based navigational instruction by the user. The navigational user interface does not interpret movement of a tapping implement within the “just tap” zone 1740 as a “tap and drag” gesture. Advantageously, the “just tap” zone 1740, therefore, forgives (i.e., allows for) slight movement of the tapping implement during a tapping motion without misinterpreting the tap as a navigation gesture.

When the tapping implement moves along the display area from the tap location 1730 to a location outside of the “just tap” zone 1740, however, the navigational user interface interprets the movement as a “tap and drag” gesture and ascertains a navigational instruction from the gesture. Dragging the tapping implement outside the “just tap” zone 1740 in any direction, therefore, commits the user to the “tap and drag” gesture.

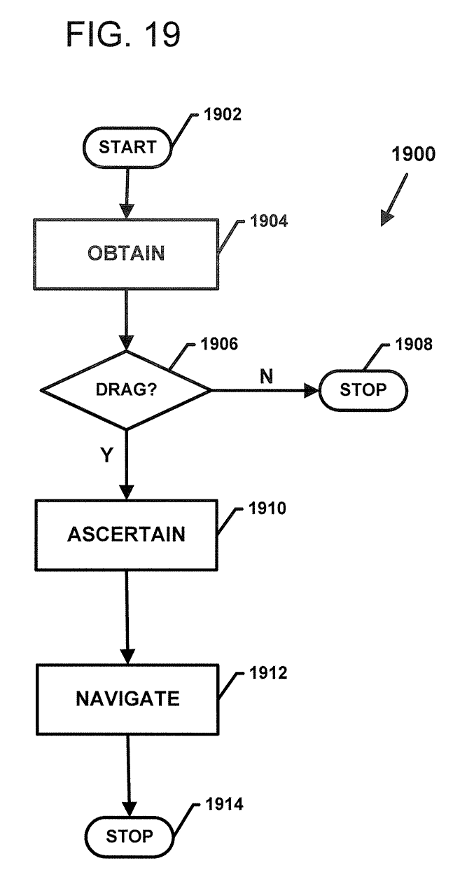

FIG. 19 is a flowchart illustrating an operational flow for a determine process 1900 by which the navigational user interface, such as interface 1700, ascertains and interprets a gesture-based navigational instruction. The determine process 1900 initializes and begins at a start module 1902 and proceeds to an obtain operation 1904. The obtain operation 1904 receives information indicating the performance of a tapping motion on the display area of the user interface. The obtain operation 1904 determines the location of the tapping motion.

A drag module 1906 determines whether a drag motion is subsequently detected. The drag module 1906 defines a “just tap” zone, such as “just tap” zone 1740 of FIG. 18. If the drag module 1906 determines a tapping implement is not dragged from the location of the tapping motion to an area outside the “just tap” zone, then the determine process 1900 completes and ends at a stop module 1908. The determine process 1900 returns information indicating the tapping motion is not a “tap and drag” gesture.

Alternatively, if the drag module 1906 determines the tapping implement is dragged from the location of the tapping motion to an area outside the “just tap” zone, then an ascertain operation 1910 divides the display area of the user interface into navigation instruction zones, such as the zones 1750, 1760, 1770, 1780 of FIG. 18. The ascertain operation 1910 also determines into which zone the tapping implement is dragged. The ascertain operation 1910 ascertains the navigation instruction provided by the user based on the zone into which the tapping implement is dragged.

In one embodiment, the ascertain operation 1910 determines the zone first entered by the tapping implement after leaving the “just tap” zone. In another embodiment, the ascertain operation 1910 determines the zone last entered by the tapping implement after leaving the “just tap” zone and before the gesture is finalized. For example, the ascertain operation 1910 can determine the zone last entered by the tapping implement before the tapping implement is lifted from the touch screen. In other embodiments, the ascertain operation 1910 can apply other logical rules to determine the intended zone.

Typically, the ascertain operation 1910 will not process further movement of the tapping implement after the drag portion of the gesture is finalized until a new tapping motion is detected. As noted above, finalizing can include lifting a tapping implement from the touch screen. In other embodiments, however, a gesture is considered to be finalized when the ascertain operation 1910 ascertains a navigational instruction.

A navigate operation 1912 changes the display of the navigational user interface based on the ascertained navigation instruction. For example, the navigate operation 1912 can display the next content page if the tapping implement is dragged from the tapping location to an increment page zone. The determine process 1900 completes and ends at a stop module 1914.

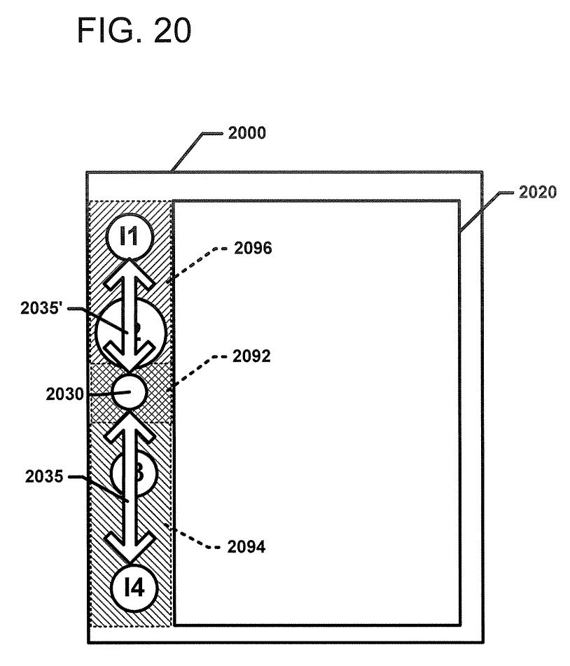

Referring to FIGS. 20-22, a navigation bar gesture initiates a version of the acceleration mode disclosed above for quickly selecting a new category. For example, an example navigational user interface 2000 can process a navigation bar gesture initiated by the user within an area defined by a navigation bar 2010. When the interface 2000 is configured in acceleration mode, display elements 2012 representing the available categories scroll upward, stall, or scroll downward based on the motion of the tapping implement until the navigation bar gesture is finalized.

In certain embodiments, the navigational user interface 2000 will interpret the motion of a tapping implement as a navigation bar gesture only if the tapping implement first taps the touch screen within the navigation bar 2010 and then drags along the touch screen. If the initial tap occurs outside the navigation bar 2010, then the navigational user interface 2000 interprets the movement as a basic navigation gesture disclosed above. In other embodiments, the navigation bar gesture (i.e., the tap and the drag movements) must be performed completely within the confines of the navigation bar 2010.

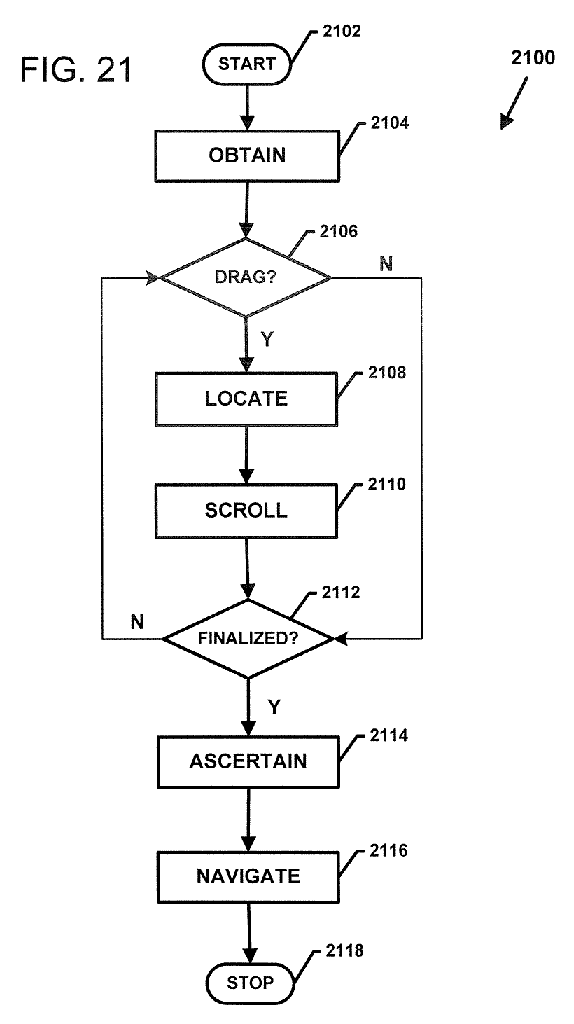

FIG. 21 is a flowchart illustrating an accelerated scrolling process 2100 by which a user can cycle quickly through display elements 2012 representing available categories to select a new category to access. The accelerated scrolling process initializes and begins at a start module 2102 and proceeds to an obtain operation 2104. The obtain operation 2104 receives information indicating the performance of a tapping motion on the touch screen. For example, the obtain operation 2104 can receive information indicating the performance of a tapping motion on the area of the touch screen displaying the navigation bar 2010. In one embodiment, touching the tapping implement to the touch screen within an area overlaying the navigation bar 2010 is interpreted as an instruction to initiate the accelerated scrolling process 2100.

A drag module 2106 determines whether a drag motion is subsequently detected. The drag module 2106 defines a “stall” zone, such as “stall” zone 2092 of FIG. 20. If the drag module 2106 determines a tapping implement is dragged (e.g., see arrows 235, 235′) from the location of the tapping motion 2030 to an area outside the “stall” zone 2092, then the scroll process 2100 proceeds to a locate operation 2108. If the tapping implement is only dragged over the “stall” zone 2092, then scrolling is halted and/or stalled.

The locate operation 2108 determines the direction in which the tapping implement is dragged. For example, as shown in FIG. 20, the locate operation 2108 defines an area (e.g., area 2094) on one side of the tapping point 2030 as an incremental scroll zone and an area (e.g., area 2096) on the opposite side of the tapping point 2030 as a decremental scroll zone. The locate operation 2108 determines the zone 2092, 2094, 2096 into which the tapping implement is dragged from the tapping location.

A scroll operation 2110 cycles through the display elements 2012 in a direction based on the scroll zone 2092, 2094, 2096 entered by the tapping implement. For example, if the tapping implement is dragged over the incremental scroll zone 2094, then the scroll operation 2110 cycles through the display elements 2012 in a first direction. If the tapping implement is dragged over the decremental scroll zone 2096, however, then the scroll operation 2110 cycles through the display elements 2012 in a second, opposite direction. Advantageously, the scroll operation 2110 facilitates quick access to display elements 2012 that are not visible on the navigation bar 2010, thereby facilitating access to the represented categories.

In certain embodiments, the navigational user interface 2000 shows an animation of the display elements 2012 scrolling in the appropriate direction during the scrolling operation 2110. Showing the animation enables a user to access display elements 1012 that initially are not visible in the navigation bar 2010. In other embodiments, however, the navigational user interface 2000 does not display an animation. Rather, the display elements 2012 remain in place and are sequentially modified (e.g., enlarged) to indicate when each is selected during the cycle. In one embodiment, no content data is displayed in the content panel 2020 while scrolling through the categories.

A finalized module 2112 determines whether the “tap and hold” gesture has been completed. In one embodiment, the gesture can be finalized by lifting the tapping implement off the touch screen. In another embodiment, dragging the tapping implement over the stall zone 2092 for a predetermined period of time indicates completion of the gesture. For example, in one embodiment dragging the tapping implement over the stall zone 2092 for 300 ms may indicate completion of the gesture. In other embodiments, however, dragging the tapping implement over the stall zone 2092 does not, by itself, indicate completion of the gesture.

If the gesture is not finalized, then the scrolling process 2100 returns to the drag module 2106. By looping back in this manner, the accelerated scrolling process 2100 enables the user to alternately scroll in opposite directions without initiating a new gesture. For example, if a user taps on the navigation bar 2010 portion of the touch screen with a tapping implement and drags the tapping implement into the incremental scroll zone 2094, then the display elements 2012 begin cycling continuously in a first direction. To pause the scrolling of the display elements 2012, the user can drag the tapping implement back to the stall zone 2092. To reverse the direction in which the display elements 2012 cycle, the user drags the tapping element into the decremental scroll zone 2096. The user can repeatedly change scrolling directions through dragging motions until finalizing the gesture.

When the gesture is finalized, the scrolling process 2100 proceeds to an ascertain operation 2114. The ascertain operation 2114 determines which category is represented by the selected display element 2012 when the scrolling process 2100 stops cycling through the categories. A navigate operation 2116 accesses the category represented by the selected display element 2012 and renders a default content page associated with the category. The scrolling process 2100 completes and ends at a stop module 2118.

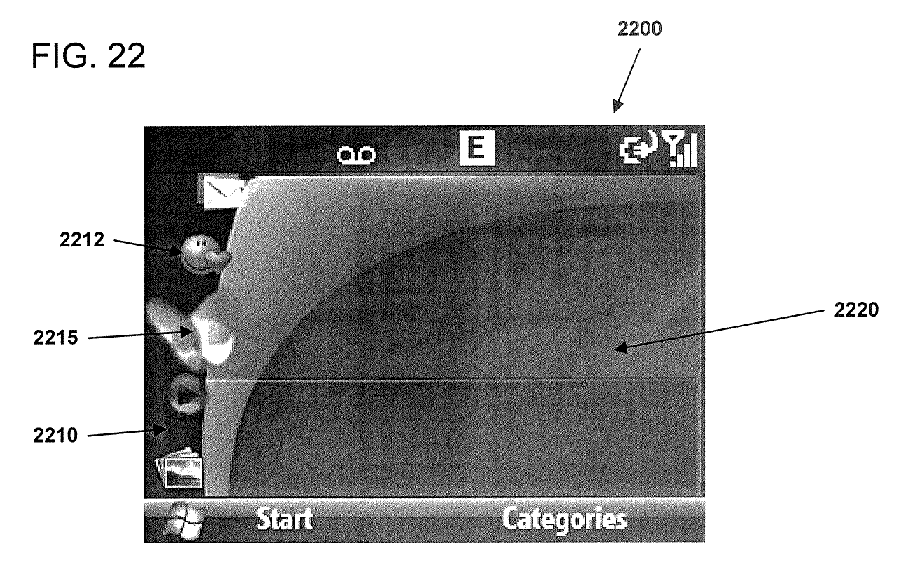

FIG. 22 illustrates an example navigational user interface 2200 including a navigation bar 2210 and a content panel 2220. Display elements 2212 are arranged with the navigation bar 2210. A selected one 2215 of the display elements 2212 is differentiated from the remaining display elements 2212 through size and color. In the example shown, accelerated scrolling has been initiated and the content panel 2220 contains a blank background. A content page will be loaded into the content panel 2220 when a category has been selected.

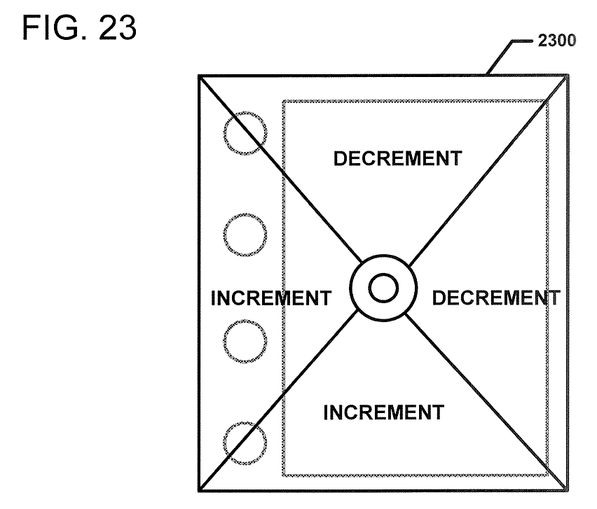

Referring to FIG. 23-25, different users may disagree on which dragging direction is intuitively associated with which navigational instruction. Some users may believe UP and RIGHT should be associated with incremental navigation whereas DOWN and LEFT should be associated with decremental navigation (see FIG. 18). Other users, however, may believe UP and RIGHT should be associated with decremental navigation whereas DOWN and LEFT should be associated with incremental navigation (see FIG. 23).

To accommodate both types of users, a navigational user interface may allow a user to select a preference of which directions (e.g., up, down, left, right) to associate with incremental navigation and which directions to associate with decremental navigation. The user's preference is typically stored in system memory with other types of configuration data (e.g., see FIG. 2 at 226). Enabling the user to select and store the user's preference enhances usability of the gesture-based communications.

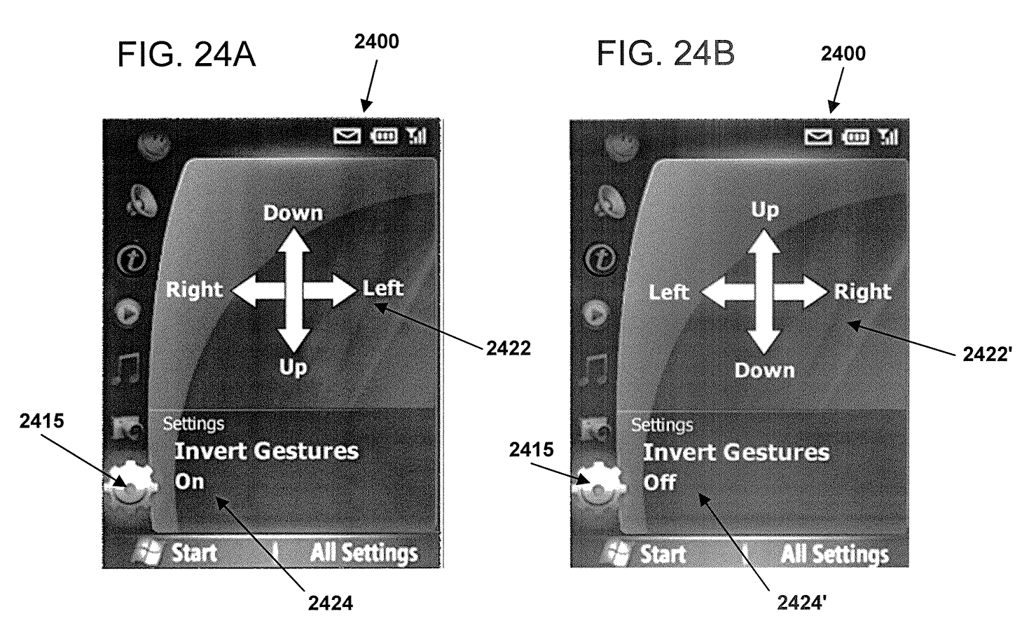

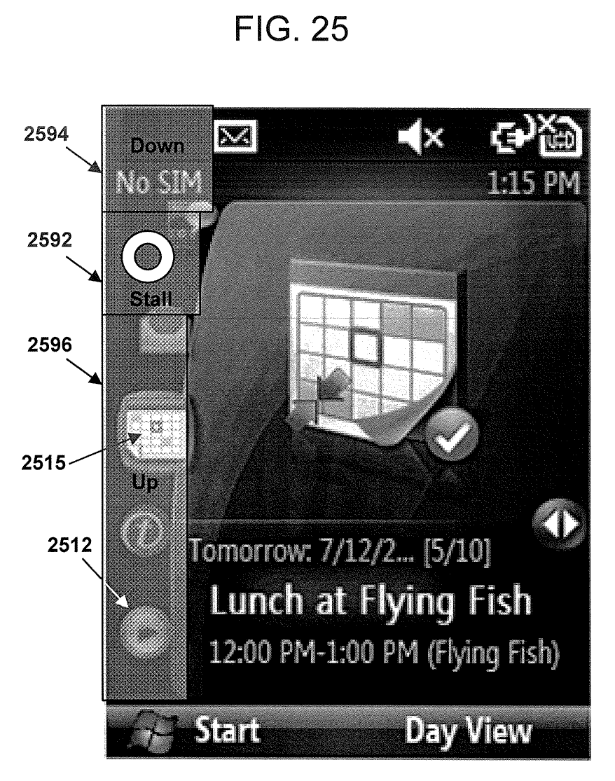

For example, with reference to FIGS. 24A and 24B, a navigational user interface may store the user's preference as content data on an “invert gestures” content page organized under a “settings” category. For example, FIGS. 24(A-B) illustrate a navigational user interface 2400 having a content panel 2420 and a navigation bar 2410. A display element 2415 representing a settings category is selected on the navigation bar 2410. The content page 2420 displays content data 2422 and a toggle element 2424. The content data 2422 indicates the correlation between drag direction and navigation direction. The toggle element 2424 enables a user to selectively configure the navigational user interface 2400 in an “invert gesture off” state and an “invert gesture on” state.

In FIG. 24A, the content data 2422 indicates directions UP and RIGHT are incremental directions, while DOWN and LEFT are decremental directions. The toggle element 2424 of FIG. 24A indicates the navigational user interface 2400 is configured in an “invert gesture off” state. In FIG. 24B, however, the user has selected the toggle element 2424 to configure the navigational user interface 2400 into the “invert gesture on” state. Accordingly, the content data 2422 indicates directions UP and RIGHT are decremental directions, while DOWN and LEFT are incremental directions.

FIG. 25 illustrates the effect inverting gestures has on the accelerated scrolling mode described above. In general, inverting gestures will invert the definitions of the incremental zone and the decremental zone. In FIG. 25, the user interface has been configured into an “invert gestures on” state. Dragging a tapping implement into the upper zone 2494 will continuously decrement the categories (i.e., the category associated with the display element 2512 positioned below the display element 2515 of the selected category will be the next selected category). If the user interface of FIG. 25 were to be configured into an “invert gestures off” state, then dragging a tapping implement into the upper zone 2494 would continuously increment the categories.

Embodiments of the disclosure described above may be implemented as a computer process (method), a computing system, or as an article of manufacture, such as a computer program product or computer readable media. The computer program product may be a computer storage media readable by a computer system and encoding a computer program of instructions for executing a computer process. The computer program product also may be a propagated signal on a carrier readable by a computing system and encoding a computer program of instructions for executing a computer process.

These computer processes can be implemented in any number of ways, including the structures described in this document. One such way is by machine operations, of devices of the type described in this document. Another optional way is for one or more of the individual operations of the methods to be performed in conjunction with one or more human operators performing some. These human operators need not be collocated with each other, but each can be only with a machine that performs a portion of the program.

While the embodiments have been described in the general context of program modules that execute in conjunction with an application program that runs on an operating system on a personal computer, those skilled in the art will recognize that aspects may also be implemented in combination with other program modules. Further, while specific file formats and software or hardware modules are described, a system according to embodiments of the present disclosure is not limited to the definitions and examples described above. Displaying and manipulating data may be performed using other file formats, modules, and techniques.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A user interface implemented on a computing system, the user interface comprising:
a display space for displaying a selected page associated with a selected category of a sequence of categories, the selected page filling a substantial portion of the display space, each of the categories being associated with at least one page, each of the pages being associated with one of the categories;
a category input configured to cycle through the categories to select a new category as the selected category when the category input is selected, wherein a default page associated with the selected category is selected as the selected page when the new category is selected; and wherein the category input can be selected regardless of what page is the selected page; and
a page input configured to cycle through the pages associated with the selected category to select a new page to become the selected page when the page input is selected.

2. The interface of claim 1, wherein the category input includes an increment option and a decrement option, wherein selection of the increment option of the category input increments through the categories to select a next category as the selected category; and wherein selection of the decrement option of the category input decrements through the categories to select a previous category as the selected category.

3. The interface of claim 1, further comprising a navigation bar arranged adjacent the selected page in the display space, the navigation bar including a display element representing each category.

4. The interface of claim 3, wherein the display element that represents the selected category is differentiated in the display space from the display elements representing other categories.

5. The interface of claim 3, wherein only a subset of the display elements is visible within the navigation bar in the display space.

6. The interface of claim 5, wherein each display element becomes visible when an animation cycling through the display elements is displayed.

7. The interface of claim 1, wherein the display space is presented on a touch sensitive screen.

8. A method for navigating among content data stored on an electronic device, the electronic device including a touch screen interface configured to display a selected page associated with a selected category of a sequence of categories, each of the categories being associated with at least one page, each of the pages being associated with one of the categories, the method comprising:
receiving a first navigational input, the first navigational input indicating when a tapping motion is performed;
determining a location at which the tapping motion is performed;
receiving a second navigational input, the second navigational input indicating whether a subsequent dragging motion is performed from the location at which the tapping motion is performed;
determining a navigation action associated with the tapping motion if a subsequent dragging motion is not performed;
determining a navigation action associated with the dragging motion if a subsequent dragging motion is performed; and
implementing the navigation action to navigate among the content data, wherein the navigation action includes one of cycling through the categories to select a new category as the selected category and cycling through the pages associated with the selected category to select a new page to become the selected page; and
wherein the first and second navigational inputs can be received regardless of which page is the selected page.

9. The method of claim 8, wherein determining a navigation action associated with the dragging motion comprises:
determining a navigational direction in which the dragging motion is performed; and
determining a navigational instruction associated with the navigational direction.

10. The method of claim 8, wherein determining the navigation action associated with the tapping motion comprises determining the navigation action based on the location at which the tapping motion occurs.

11. The method of claim 8, wherein implementing the navigation action to navigate among the content data comprises displaying the selected page of the selected category after completing the navigation action.

12. A computer readable storage medium storing computer executable instructions for performing a method of scrolling through a plurality of display elements arranged on a navigation bar displayed to a user, each display element being associated with one of a plurality of categories, the method comprising:
displaying a first content page and the navigation bar to the user, the first content page being associated with one of the categories;
receiving a first navigational input indicating a tapping gesture is performed within the navigation bar with a tapping implement;
determining a location within the navigation bar at which the tapping gesture is performed;
dividing the navigation bar into a plurality of zones including a stall zone, an increment zone, and a decrement zone based on the location at which the tapping gesture is performed;
receiving a second navigational input indicating the tapping implement is dragged from the location at which the tapping gesture is performed to one of the stall zone, the increment zone, and the decrement zone;
continuously cycling through selection of the display elements incrementally when the tapping implement is dragged from the location at which the tapping gesture is performed to the increment zone, wherein selection of the display elements during the continuous incremental cycling does not present a content page associated with each display element to the user when the respective display element is selected;
continuously cycling through selection the display elements decrementally when the tapping implement is dragged from the location at which the tapping gesture is performed to the decrement zone, wherein selection of the display elements during the continuous decremental cycling does not present a content page associated with each display element to the user when the respective display element is selected; and
halting cycling of the display elements on a currently selected display element when the tapping implement is dragged only within the stall zone, wherein halting cycling of the display elements on a currently selected display element includes continuing to display the first content page to the user.

13. The computer readable medium of claim 12, further comprising dragging the tapping implement from one of the increment zone and the decrement zone to the stall zone to halt cycling of the display elements.

14. The computer readable medium of claim 13, further comprising:
receiving a third navigational input, the third navigational input indicating the scrolling is finalized; and
accessing the category associated with the currently selected display element.

15. The computer readable medium of claim 14, wherein receiving a third navigational input comprises receiving the third navigational input indicating the tapping implement has been lifted from the navigation bar.

16. A computer system comprising:
a display configured to present content and to receive input;
a system memory communicatively coupled to the display, the system memory being configured to store:
a drag module configured to receive a signal indicating a dragging motion has been performed using the display, the drag module being further configured to determine a direction in which the dragging motion is performed;
a processing module configured to ascertain a navigation instruction based on the direction in which the dragging motion is performed, the navigation instruction including one of at least two navigation types and one of at least two navigation directions associated with the direction in which the dragging motion is performed;
an invert module configured to selectively invert which of the at least two navigation directions is associated with the direction in which the dragging motion is performed; and
a processor communicatively coupled to the system memory, the processor being configured to process each of the modules stored in the system memory to implement the navigation instruction to modify the content presented on the display.

17. The computer system of claim 16, wherein the invert module is configured to selectively invert which of the at least two navigation types is associated with the direction in which the dragging motion is performed.

18. The computer system of claim 16, wherein the navigation types include category navigation and page navigation.

19. The computer system of claim 16, wherein the invert module is implemented as a toggle element arranged on a content page that can be presented on the display.

20. The computer system of claim 16, further comprising:
a tap module configured to receive a signal indicating a tapping motion has been performed, the tap module further configured to determine a location at which the tapping motion occurred, wherein the drag module determines a direction in which the dragging motion is performed based on the location at which the tapping motion occurred.
